(19) United States
(12) Patent Application Publication
(10) Pub. No.: US 2026/0348094 A1
(43) Pub. Date: Nov. 5, 2026

(54) CREPED HESPERALOE TISSUE PRODUCTS

(71) Applicant: Kimberly-Clark Worldwide, Inc., Neenah, WI (US)

(72) Inventors: Samantha C. Ackerly, Palmer, AK (US); Thomas G. Shannon, Neenah, WI (US); Zhiying Yu, Neenah, WI (US); Richard L. Underhill, Neenah, WI (US)

(21) Appl. No.: 19/487,271

(22) PCT Filed: May 31, 2024
(86) PCT No.: PCT/US2024/031838

§ 371 Date: Nov. 24, 2025

Related U.S. Application Data
(60) Provisional application No. 63/469,925, filed on May 31, 2023.

(51) Int. Cl. D21H 11/12; B32B 3/28; B32B 29/00; D21H 27/00; D21H 27/40

(52) U.S. Cl. CPC D21H 11/12; B32B 3/28; B32B 29/005; D21H 27/005; D21H 27/40; B32B 2250/02; B32B 2250/26; B32B 2307/54; B32B 2307/718

(57) ABSTRACT

Creped tissue products comprising non-wood fibers and more particularly high yield hesperaloe pulp fibers are disclosed. The creped tissue products preferably comprise at least about 5 percent, by weight of the product, high yield hesperaloe pulp fiber and have relatively modest tensile strengths, such as a geometric mean tensile (GMT) ranging from about 500 to 1,200 g/3″. The tissue products have a high degree of softness, such as a TS7 value less than about 15.0, yet are highly durable, such as having a Durability Index of about 30 or greater. The tissue products may be produced by blending high yield hesperaloe pulp fibers with wood pulps fibers, wet forming a tissue web, drying the tissue web on a cylindrical dryer and creping the dried tissue web to remove it from the drier. The resulting creped tissue webs are particularly well suited for use as single ply and multiply bath tissue products or multiply facial tissue products and may consist of rolled or folded and stacked sheets comprising multiple tissue plies.

### BACKGROUND OF THE DISCLOSURE

Tissue products, such as facial tissues, paper towels, bath tissues, napkins, and other similar products, are designed to include several important properties. For example, the products should have good bulk, a soft feel, and should have good strength and durability. Unfortunately, however, when one of these properties is improved another is often adversely affected.

The balance of physical properties desired in tissue products has typically been achieved using one or more wood fibers, often referred to as pulp or pulp fibers, which commonly include chemical pulps, such as kraft (sulphate) and sulfite pulps, as well as chemimechanical pulp (CMP) and chemithermomechanical pulp (CTMP). Chemical pulps are believed to impart a superior sensation of softness to tissue products made from these pulps. Wood pulps are commonly derived from both deciduous trees (referred to herein as “hardwood”) and coniferous trees (herein referred to as “softwood”), which may be selected and incorporated into the tissue product based upon their physical attributes and the desired physical properties of the resulting tissue product.

To achieve an optimal balance of tissue product properties, the products are often formed from a combination of chemical pulps derived from hardwood and softwood fibers. For example, to optimize surface softness, as is often the case with tissue products, the papermaker will select the fiber furnish based in part on the coarseness of pulp fibers. Pulps having fibers with low coarseness, such as chemical hardwood pulp fibers, are desirable because the tissue product may be softer compared to a comparable product made from fibers having a high coarseness. To optimize surface softness even further, layered structures may be used such that the low coarseness fibers are disposed in the outer layers, where they contact the user, while the inner layer consists of coarser fibers.

Unfortunately, the need for softness is balanced by the need for durability. Durability in tissue products can be defined in terms of tensile strength, tensile energy absorption (TEA), burst strength and tear strength. Typically tear, burst and TEA will show a positive correlation with tensile strength while tensile strength, and thus durability, and softness are inversely related. Thus, the tissue maker is continuously challenged with the need to balance the need for softness with a need for durability. Long papermaking fibers may improve durability, but they may adversely affect softness.

Northern softwood kraft (NSWK) fibers are long fiber of choice for tissue makers because of their ability to provide the best combination of durability and softness, particularly. While NSWK fibers are more coarseness then hardwood pulp fibers, their small cell wall thickness relative to lumen diameter combined with their long length makes them the ideal candidate for optimizing durability and softness in tissue. Unfortunately supply of NSWK is under significant pressure both economically and environmentally. As such, prices of NSWK have escalated significantly creating a need to find alternatives to optimize softness and strength in tissue products. Alternatives, however, are limited. For example, Southern softwood kraft (SSWK) may only be used in limited amounts in the manufacture of tissue products because its high coarseness results in stiffer, harsher feeling products than NSWK.

The pressures placed upon NSWK has led tissue makers to search for alternatives, particularly amongst non-wood fibers. For example, U.S. Pat. No. 5,320,710 discloses the manufacture of tissue using hesperaloe pulp produced by a conventional kraft process. The tissue products, while having certain improved physical properties, were deficient, compared to those produced with NSWK, in terms of bulk, tensile and stiffness. Thus, the tissue products of the '710 patent were generally not suitable for use as premium bath tissue because the strengths and stiffness were excessively high. For example, when compared to Northern® Bathroom Tissue the products of the '710 patent had 300 percent greater tensile strength (measured as GMT) and nearly 250% greater stiffness (measured as GMT divided by Modulus).

Some of these deficiencies of kraft hesperaloe pulp were overcome by pulping hesperaloe using high yield pulping processes. For example, U.S. Pat. No. 10,337,149, disclose tissue products made with high yield hesperaloe pulp, but even then, balancing strength and softness proved difficult. High yield pulping processes where able to moderate the tensile strength of resulting tissue products but tensile still increased relative to products containing NSWK and the increase was not offset by large decrease in stiffness. As a result, substitution of NSWK with high yield hesperaloe pulp often had a negative effect on softness.

The softness of tissue products containing hesperaloe pulps has also been hindered by the presence of non-fibrous debris, often in the form of epidermal cells. Hesperaloe plants have tough epidermal and hypodermal tissues that form non-fibrous debris in the resulting pulps. This debris does not readily bond to the fibers and is often deposited on the surface of the tissue where it can negatively affect softness, particularly in creped tissue products, which often have relatively flat, planar surfaces. Thus, there remains a need for tissue products, particularly creped tissue products, which substitute NSWK fibers with non-wood fibers, without negatively affecting strength and softness.

### SUMMARY OF THE DISCLOSURE

The present inventors have successfully used non-wood pulps, particularly pulps produced from hesperaloe, to produce tissue products having softness, strength and bulk comparable or better than that achieved using conventional wood pulp. To produce the instant tissue products the inventors have successfully moderated the changes in strength and stiffness typically associated with substituting conventional wood papermaking fibers, such as NSWK, with non-wood fibers. These changes have generally been achieved by a variety of means, including the use of hesperaloe pulps produced by high yield pulping processes, particularly processes involving mechanical separation of individual fibers and the reduction of fiber length and subsequent cleaning of the pulp to remove epidermal debris.

The removal of epidermal debris makes the hesperaloe pulps particularly well suited to the manufacture of creped tissue products. Accordingly, in certain instances, the present invention provides a creped tissue product having a Finished Product Debris less than 1.00%, such as less than about 0.75%, such as less than about 0.5%, such as from about 0.10 to about 1.00%, such as from about 0.10 to about 0.50%.

The resulting tissue products generally have a moderate degree of tensile strength. In certain instances the tissue products may comprise a single creped tissue ply and have a geometric mean tensile (GMT) rom about 500 g/3″ to about 1,000 g/3″, such as from about 550 g/3″ to about 850 g/3″. In other instances the tissue products may comprise two or more creped tissue plies and the multiply product may have a GMT ranging from about 600 g/3″ to about 1,750 g/3″, such as from about 750 g/3″ to about 1,250 g/3″, such as from about 800 to about 1,100 g/3″.

In addition to having a moderate degree of tensile strength, the tissue products may have a high degree of softness (measured using a Tissue Softness Analyzer as described in the Test Methods below) such as a TS7 value less than about 15.0. such as less than about 14.0, such as less than about 13.0, such as less than about 12.0, such as less than about 11.0, such as less than about 10.0, such as from about 8.0 to about 15.0 and more preferably from about 8.0 to about 12.0 and still more preferably from about 8.0 to about 10.5.

Surprisingly, the improvement in strength and softness may be achieved by distributing the hesperaloe pulp fibers in multiple layers, or throughout the entire tissue web. Thus, in certain instances, the present invention provides tissue products comprising at least one tissue web or ply comprising a blend of hesperaloe pulp fibers and wood pulp fibers. In this manner the tissue web or ply may be stratified, comprising multiple layers, and the hesperaloe pulp fiber may be disposed in multiple layers, or it may be unstratified and the hesperaloe pulp fibers may be distributed throughout the web or ply.

Thus, in certain instances the present invention provides a provides tissue products comprising at least one tissue web or ply comprising a blend of hesperaloe pulp fibers and wood pulp fibers, where the fibers are blended such that at least a portion of the hesperaloe pulp fibers are present in the surface of the tissue product brought into contact with a user's skin in-use. Despite having hesperaloe pulp fibers disposed in the outer surface, the inventive tissue products have a high degree of softness. For example a multiply tissue product comprising at least 5% high yield hesperaloe pulp may have a TS7 value equal or less than 0.0056(GMT)+5.5615 where GMT is the geometric mean tensile strength of the tissue product having units of grams per three inches. The geometric mean tensile strength of the tissue products may range from about 600 g/3″ to about 1,750 g/3″, such as from about 750 g/3″ to about 1,250 g/3″, such as from about 800 to about 1,100 g/3″.

In other instances the tissue product may consist of a single ply, creped, bath tissue product comprising a creped single ply web spirally wound around a core, the product comprising at least 5% high yield hesperaloe pulp and having a TS7 value equal or less than 0.0119(GMT)+6.6187 where GMT is the geometric mean tensile strength of the tissue product having units of grams per three inches. The geometric mean tensile strength of the single ply tissue products may range from about 500 g/3″ to about 1,000 g/3″, such as from about 550 g/3″ to about 850 g/3″.

In other instances, the creped tissue products may have a Stiffness Index about 10.0 or less, such as less than about 9.0, such as less than about 8.0, such as from about 6.0 to about 10.0. In this manner the inventive tissue products have a relatively low degree of stiffness, which combined with a high degree of softness, provide the tissue products with a good handfeel. Surprisingly, the low levels of stiffness are achievable even when hesperaloe pulp fibers are present throughout the web, rather then being selectively disposed in a single layer. In this manner hesperaloe pulp fibers may be present on the product surface, where they are brought into contact with a user's skin, without stiffening the product. Furthermore, because the hesperaloe pulps preferably have a low degree of epidermal debris, the pulp fibers may be present along the outer surface without causing the surface to be overly rough or abrasive.

In still other aspects the present invention provides tissue products having relatively moderate amounts of long average fiber length kraft fibers, such as softwood kraft pulp fibers, or are substantially free from long average fiber length kraft fibers. For example, the tissue products may comprise less than about 10 wt %, based upon the total weight of the tissue product, softwood kraft pulp fibers. In other instances, the tissue products of the present invention may be substantially free from softwood kraft pulp fibers, particularly NSWK.

### DESCRIPTION OF THE DRAWINGS

FIG. 1 is a cross-sectional view of a blended tissue web.

FIG. 2 is a cross-sectional view of a layered tissue web.

FIG. 3 is a schematic diagram of one process for forming wet pressed, creped tissue webs for use in the present disclosure.

FIG. 4 is a graph illustrating the relationship between geometric mean tensile (GMT, having units of g/3″) and TS7 for a tissue product comprising EHWK and NSWK fibers (●); a tissue product comprising EHWK (75 wt %) and high yield hesperaloe pulp fiber (25 wt %) (▴); a tissue product comprising EHWK (85 wt %) and high yield hesperaloe pulp fiber (15 wt %) (♦); and a tissue product comprising EHWK (95 wt %) and high yield hesperaloe pulp fiber (5 wt %) (▪).

FIG. 5 is a graph illustrating the relationship between geometric mean tensile (GMT, having units of g/3″) and aTS750 for a tissue product comprising EHWK and NSWK fibers (●); a tissue product comprising EHWK (75 wt %) and high yield hesperaloe pulp fiber (25 wt %) (▴); a tissue product comprising EHWK (85 wt %) and high yield hesperaloe pulp fiber (15 wt %) (♦); and a tissue product comprising EHWK (95 wt %) and high yield hesperaloe pulp fiber (5 wt %) (▪).

FIG. 6 is a graph illustrating the relationship between geometric mean tensile (GMT, having units of g/3″) and geometric mean slope (GM Slope, having units of kg for a tissue product comprising EHWK and NSWK fibers (●); a tissue product comprising EHWK (75 wt %) and high yield hesperaloe pulp fiber (25 wt %) (▴); a tissue product comprising EHWK (85 wt %) and high yield hesperaloe pulp fiber (15 wt %) (♦); and a tissue product comprising EHWK (95 wt %) and high yield hesperaloe pulp fiber (5 wt %) (▪).

FIG. 7A is an image of a tissue product comprising 30% hesperaloe pulp and comprising 3.2% Product Debris; FIG. 7B is an image of a tissue product comprising 40% hesperaloe pulp and comprising 0.3% Product Debris.

FIG. 8 is a graph illustrating the relationship between geometric mean tensile (GMT, having units of g/3″) and TS7 for a tissue product comprising EHWK and NSWK fibers (●); and a tissue product comprising EHWK (75 wt %) and high yield hesperaloe pulp fiber (25 wt %) (▪).

### DEFINITIONS

As used in this application and in the claims, the singular forms “a,” “an,” and “the” include the plural forms unless the context clearly dictates otherwise. Thus, for example, reference to a “yarn” includes aspects having two or more such yarns unless the context clearly indicates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Additionally, the term “includes” means “comprises.”

For the terms “for example,” “exemplary,” and “such as,” and grammatical equivalences thereof, the phrase “and without limitation” is understood to follow unless explicitly stated otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint and independently of the other endpoint.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein the term “Basesheet” refers to a tissue web formed by any one of the papermaking processes described herein that has not been subjected to further processing, such as embossing, calendering, treatment with a binder or softening composition, perforating, plying, folding, or rolling into individual rolled products.

As used herein the term “Tissue Product” refers to products made from basesheets and includes, bath tissues, facial tissues, paper towels, industrial wipers, foodservice wipers, napkins, medical pads, and other similar products.

As used herein the term “Ply” refers to a discrete tissue web used to form a tissue product. Individual plies may be arranged in juxtaposition to each other.

As used herein, the term “Layer” refers to a plurality of strata of fibers, chemical treatments, or the like, within a ply. The term “Layered Tissue Web” generally refers to a tissue web formed from two or more layers of aqueous papermaking furnish. In certain instances, the aqueous papermaking furnish forming two or more of the layers comprise different fiber types.

As used herein the term “Basis Weight” generally refers to the bone-dry weight per unit area of a tissue and is generally expressed as grams per square meter (gsm). Basis weight is measured as described in the Test Methods section below. While the basis weights of tissue products prepared according to the present invention may vary, in certain instances the products may have a basis weight ranging from about 20 gsm to about 80 gsm, such as from about 30 gsm to about 50 gsm, including exemplary values of about 20 gsm, about 25 gsm, about 30 gsm, about 32 gsm, about 34 gsm, about 36 gsm, about 38 gsm, about 40 gsm, about 42 gsm, about 44 gsm.

As used herein, the term “Caliper” refers to the thickness of a tissue product, web, sheet or ply, typically having units of microns (μm) and is measured as described in the Test Methods section below.

As used herein, the term “Sheet Bulk” refers to the quotient of the caliper (μm) divided by the bone-dry basis weight (gsm). The resulting sheet bulk is expressed in cubic centimeters per gram (cc/g). Tissue products prepared according to the present invention may, in certain instances, have a sheet bulk greater than about 8.0 cc/g, more preferably greater than about 9.0 cc/g and still more preferably greater than about 10.0 cc/g, such as from about 8.0 to about 12.0 cc/g.

As used herein, the term “Slope” refers to the slope of the line resulting from plotting tensile versus stretch and is an output of the MTS TestWorks™ in the course of determining the tensile strength as described in the Test Methods section herein. Slope is reported in the units of grams (g) per unit of sample width (inches) and is measured as the gradient of the least-squares line fitted to the load-corrected strain points falling between a specimen-generated force of 70 to 157 grams (0.687 to 1.540 N) divided by the specimen width.

As used herein, the term “Geometric Mean Slope” (GM Slope) generally refers to the square root of the product of machine direction slope and cross-machine direction slope. While the GM Slope may vary amongst tissue products prepared according to the present disclosure, in certain instances, may have a GM slope of less than or equal to about 10 kg. In other aspects, the GM slope can be about 5.0 kg to about 10.0 kg or about 8.0 kg to about 10.0 kg, including example values of about 6.5 kg, about 7.0 kg, about 7.2 kg, about 7.4 kg, about 7.6 kg, about 7.8 kg, about 8.0 kg, about 8.2 kg, about 8.4 kg, about 8.6 kg, about 8.8 kg, about 9.0 kg, about 9.2 kg, about 9.4 kg, about 9.6 kg, and about 9.8 kg.

As used herein, the term “Geometric Mean Tensile” (GMT) refers to the square root of the product of the machine direction tensile strength and the cross-machine direction tensile strength of the web. The GMT of tissue products prepared according to the present invention may vary, however, in certain instances the GMT from about 500 g/3″ to about 1,750 g/3″, such as from about 550 g/3″ to about 1,250 g/3″, such as from about 600 to about 1,100 g/3″, such as about 500 g/3″, such as about 550 g/3″, such as about 600 g/3″, about 625 g/3″, about 650 g/3″, about 675 g/3″, about 700 g/3″, about 725 g/3″, about 750 g/3″, about 775 g/3″, about 800 g/3″, about 825 g/3″, about 850 g/3″, about 875 g/3″, about 900 g/3″, about 925 g/3″, about 950 g/3″, about 975 g/3″, about 1,000 g/3″, about 1,050 g/3″, about 1,100 g/3″, about 1,150 g/3″, about 1,200 g/3″ and about 1,300 g/3″.

As used herein, the term “Stiffness Index” refers to the quotient of the geometric mean tensile slope, defined as the square root of the product of the MD and CD slopes (having units of kg), divided by the geometric mean tensile strength (having units of grams per three inches).

$$Stiffness Index = \frac{\sqrt{MD Tensile Slope ( kg ) \times CD Tensile Slope ( kg )}}{GMT ( g / {3}^{″} )} \times 1 , 000$$

While the Stiffness Index of tissue products prepared according to the present disclosure may vary, in certain instances the Stiffness Index may be about 10.0 or less, such as less than about 9.0, such as less than about 8.0, such as from about 6.0 to about 10.0, such as about 6.0, about 7.0, about 8.0, about 9.0 and about 10.0.

As used herein, the term “TEA Index” refers the geometric mean tensile energy absorption (having units of g·cm/cm²) at a given geometric mean tensile strength (having units of grams per three inches) as defined by the equation:

$$TEA Index = \frac{GM TEA ( g \cdot cm / {cm}^{2} )}{GMT ( g / {3}^{″} )} \times 1000$$

While the TEA Index may vary, in certain instances tissue products prepared according to the present disclosure have a TEA Index of about 8.0 or greater, such as about 8.5 or greater, such about 9.0 or greater, such as about 9.5 or greater, such as about 10.0 or greater, such as about 10.5 or greater, such as about 11.0 or greater, such as from about 8.0 to about 12.0.

As used herein, the term “Slough” generally refers to the undesirable sloughing off of bits of the tissue web when rubbed and is generally measured as described in the Test Methods section below. Slough is generally reported in terms of mass, such as milligrams (mg). While the Slough of inventive tissue products may vary, in certain instances tissue products prepared according to the present invention have a Slough less than about 5.00 mg and more preferably less than about 4.00 mg, such as from about 0.50 to about 5.00, such as from about 0.50 to about 4.00 mg.

As used herein, the term “TS7” generally refers to the softness of a tissue product surface measured using an EMTEC Tissue Softness Analyzer (“Emtec TSA”) (Emtec Electronic GmbH, Leipzig, Germany) interfaced with a computer running Emtec TSA software (version 3.19 or equivalent). The units of the TS7 value are dB V² rms, however, TS7 values are often referred to herein without reference to units. Generally, the TS7 value is the magnitude of the peak occurring at a frequency between about 6 and 7 Hz, which is produced by vibration of the tissue membrane during the test procedure. Generally, a lower TS7 value is indicative of a softer tissue product.

As used herein, the term “Fiber Length” refers to the length weighted average length (LWAFL) of fibers determined utilizing an OpTest Fiber Quality Analyzer-360 (OpTest Equipment, Inc., Hawkesbury, ON). The length weighted average length is determined in accordance with the manufacturer's instructions and generally involves first accurately weighing a pulp sample (10-20 mg for hardwood, 25-50 mg for softwood) taken from a one-gram handsheet made from the pulp. The moisture content of the handsheet should be accurately known so that the actual amount of fiber in the sample is known. This weighed sample is then diluted to a known consistency (between about 2 and about 10 mg/I) and a known volume (usually 200 ml) of the diluted pulp is sampled. This 200 ml sample is further diluted to 600 ml and placed in the analyzer. The length-weighted average fiber length is defined as the sum of the product of the number of fibers measured and the length of each fiber squared divided by the sum of the product of the number of fibers measured and the length of the fiber. Fiber lengths are generally reported in millimeters.

As used herein, the term “Coarseness” generally refers to the weight per unit length of fiber, commonly having units of mg/100 meters. Coarseness is measured according to ISO Coarseness Testing Method 23713 utilizing an OpTest Fiber Quality Analyzer-360 (OpTest Equipment, Inc., Hawkesbury, ON).

As used herein, the term “Very Long Fiber Fraction” generally refers to the percentage of fibers having a length (number average fiber length) greater than 6.0 mm and is generally determined using an OpTest Fiber Quality Analyzer-360 (OpTest Equipment, Inc., Hawkesbury, ON) as described in the Test Methods section below. As used herein, the term “Dispersivity Index” generally refers to the ratio of the length weighted average fiber length (Lw) to the number average fiber length (Ln). This ratio indicates the fiber length distribution of a given pulp. The length weighted average fiber length (Lw) to the number average fiber length (Ln) is generally determined using an OpTest Fiber Quality Analyzer-360 (OpTest Equipment, Inc., Hawkesbury, ON) as described in the Test Methods section below.

As used herein, the term “high yield hesperaloe pulp” refers to pulp derived from a plant of the genus Hesperaloe of the family Asparagaceae including, for example, H. funifera, H. parviflora, H. nocturna, H. chiangii, H. tenuifolia, H. engelmannii, and H. malacophylla using a high yield pulping process, such as a pulping process having a yield greater than about 60%, such as greater than about 65%, such as greater than about 70%, such as greater than about 75%, such as greater than about 80%, such as greater than about 85%, such as greater than about 90%, such as from about 60 to about 95%, such as from 75 to about 95%. The foregoing yields generally refer to the yield of unbleached hesperaloe pulp fiber.

As used herein, the term “Product Debris” refers to the amount of epidermal debris present in a tissue web or product measured as described n the Test Methods Section. In certain instances, the Product Debris is about 1.0% or less, such as about 0.75% or less, such as about 0.50% or less, such as about 0.25% or less, such as from about 0.05% to about 1.0%.

As used herein, the term “Wet Pressed” generally refers to a tissue manufacturing process and tissue products made thereby where the partially dewatered tissue web is transferred to a felt and thereafter pressed onto the surface of a dryer while supported by the felt. Examples of wet pressed and modified wet pressed processes are disclosed, for example, in U.S. Pat. Nos. 3,953,638, 5,324,575 and 6,080,279.

As used herein, the term “substantially free” means less than 3 wt %, alternatively less than 2 wt %, alternatively less than 1 wt %, alternatively less than 0.5 wt %, alternatively less than 0.25 wt %, alternatively less than 0.1 wt %, alternatively less than 0.05 wt %, alternatively less than 0.01 wt %, and/or alternatively free of. As used herein, “free of” means 0 wt %.

### DETAILED DESCRIPTION OF THE DISCLOSURE

The present inventors have now discovered that hesperaloe pulp fibers processed by high yield pulping means, such as mechanical pulping, may overcome the limitations of kraft hesperaloe pulp fibers when incorporated into tissue products such as bath tissues, facial tissues, paper towels, industrial wipers, foodservice wipers, napkins, medical pads, and the like. The inventors have discovered that mechanical pulping of hesperaloe yields a pulp having a moderate fiber length, such as a fiber length of about 1.50 mm or greater, such as from about 1.50 to about 2.50 mm, yet a low degree of coarseness, such as less than about 10.0 mg/100 m, such as from about 3.5 to about 10.0 mg/100 m. At the same time the pulp may have a moderate degree of tensile strength, such as a pulp Tensile Index of about 55 or less, such as from about 30 to about 55.

High yield hesperaloe pulps having the foregoing properties are well suited to replace conventional wood pulps commonly used in the manufacture of tissue products, particularly softwood kraft fibers, without negatively affecting important tissue product properties such as durability, stiffness or softness. In fact, in certain instances important tissue product properties may be improved by substituting conventional wood pulp fibers with hesperaloe pulp fibers. For example, tissue products produced with high yield hesperaloe pulps have a high degree of softness, measured as TS7, and moderate degree of tensile strength.

Generally, the hesperaloe pulp fibers useful in the present invention have a relatively long fiber length, such as a fiber length of about 1.50 mm or greater, such as about 1.55 mm or greater, such as about 1.60 mm or greater, such as about 1.65 mm or greater, such as about 1.70 mm or greater, such as about 1.75 mm or greater, such as from about 1.50 to about 2.50 mm, such as from about 1.55 to about 2.00 mm. The hesperaloe pulp fibers may also have a fiber coarseness less than about 10.0 mg/100 m, such as less than about 8.0 mg/100 m, such as less than about 6.0 mg/100 m, such as from about 4.0 to about 10.0 mg/100 m, such as from about 4.0 mg/100 m to about 8.0 mg/100 m.

The hesperaloe pulps may also have a relatively modest degree of tensile strength, such as a Tensile Index of about 55 or less, such as about 50 or less, such as about 45 or less, such as about from about 30 to about 55, such as from about 35 to about 50, such as from about 35 to about 45. In other instances the hesperaloe pulps may have a freeness, where a higher value is indicative of pulps that are more easily dewatered, of about 500 mL or greater, such as about 510 mL or greater, such as about 525 mL or greater, such as about 550 mL or greater, such as from about 500 mL to about 600 mL.

In other instances, the hesperaloe pulps may have a moderate degree of tensile strength and a low degree of fibers having a fiber length greater than 6.0 mm, which can inhibit dispersion of the pulp in water and cause stringing or clumping when the pulp is used to manufacture wet-laid fibrous products. For example, the inventive pulps may have a Tensile Index of about 55 or less, such as about 50 or less and a Very Long Fiber fraction (VLF) of about 1.0% or less, such as about 0.75% or less, such as a about 0.50% or less, such as a VLF from about 0.05% to about 1.0%. a fiber length from about 1.50 to about 2.50. In addition to having reduced tensile strengths and relatively long fiber lengths.

In still other instances the hesperaloe pulps may have a high degree of brightness and/or low content of epidermis debris. Brightness and reduced debris are particularly important for pulps used in the manufacture of tissue products because of the need for a white, bright appearance and a low degree of linting. Accordingly, hesperaloe pulps useful in the present invention may have a Brightness of at least about 75%, more preferably at least about 78% and still more preferably at least about 80%. In other instances, the hesperaloe pulp may have a debris content of about 1.0 wt % or less, such as about 0.90 wt % or less, such as about 0.80 wt % or less, such as about 0.60 wt % or less. In certain instances, it may be desirable to remove substantially all of the debris from the pulp such that the pulp is substantially free from, or free from, debris.

In certain preferred instances, the tissue products of the present invention are produced by a high yield pulping process High yield pulping processes useful for the manufacture of high yield hesperaloe pulps include, for example, mechanical pulp (MP), refiner mechanical pulp (RMP), pressurized refiner mechanical pulp (PRMP), thermomechanical pulp (TMP), high temperature TMP (HT-TMP), RTS-TMP, thermopulp, groundwood pulp (GW), stone groundwood pulp (SGW), pressure groundwood pulp (PGW), super pressure groundwood pulp (PGW-S), thermo groundwood pulp (TGW), thermo stone groundwood pulp (TSGW) or any modifications and combinations thereof. Preferably the high yield pulping process has a yield greater than about 60 percent, such as from about 60 to about 90 percent and more preferably from about 65 to about 90 percent. The foregoing yields generally refer to the yield of unbleached hesperaloe pulp fiber.

In certain instances, high yield hesperaloe pulps may be prepared as described in mechanical pulping process where the hesperaloe biomass or bagasse is treated with an alkaline phosphate prior to or during mechanical refining, such as described in PCT Application No. PCT/US2021/058196, the contents of which are incorporated herein in a manner consistent with the present invention.

In other instances, high yield hesperaloe pulps may be produced using a two-stage mechanical puling process where fibrillation of the hesperaloe biomass or bagasse is carried out in first mechanical pulping stage without the addition of chemicals, such alkaline peroxide chemicals, and/or other chemicals known in the art to bleach or otherwise process lignocellulosic material into pulp or precursors of pulp. Once the hesperaloe biomass or bagasse has been refined to a freeness of about 400 mL or greater, chemicals may be introduced, such as after a first mechanical pulping stage and prior to a second stage of mechanical refining. The foregoing process not only simplifies the pulping process and reduces costs, but it also improves pulp yields and the physical properties of the resulting pulp. For example, the foregoing process may be used to produce hesperaloe pulps at yields of about 80% or greater, such as about 85% or greater, such as about 90% or greater, such as yields from about 80% to about 95%.

In still other instances, high yield hesperaloe pulps may be produced without the addition of chemicals, such alkaline peroxide chemicals, and/or other chemicals known in the art to bleach or otherwise process lignocellulosic material into pulp or precursors of pulp during mechanical refining of the pulp. The hesperaloe pulp may be produced using a process comprising the steps of: (a) providing a hesperaloe biomass; (b) cutting the biomass to a nominal length; (c) extracting water soluble solids from the cut biomass to produce a bagasse; (d) mechanically refining the bagasse at a first consistency and at a pH ranging from 6.5 to 7.5 without the addition of chemicals to yield a refined bagasse; (e) mechanically refining the refined bagasse at a pH ranging from 6.5 to 7.5 without the addition of chemicals at a second consistency, wherein the second consistency is less than the first consistency, to yield a high yield hesperaloe pulp useful in the manufacture of tissue products of the present invention.

While in certain instances caustic or an oxidizing agent may be introduced to the process to facilitate fiber separation by the mechanical forces, such addition may not be necessary and in certain instances may be undesirable. For example, in certain instances it be desirable to produce hesperaloe pulp without the addition of caustic to improve yield and moderate the tensile strength of the resulting pulp. Without being bound by any particular theory, it is believed that omitting the addition of caustic during mechanic treatment, particularly mechanical treatment carried out a low consistency, such as consistencies of about 10% or less, particularly from about 3% to about 5%.

Although, in certain instances, a caustic or oxidizing agent may be added during processing, it is generally preferred that the hesperaloe pulp fiber is not pretreated with a sodium sulfite or the like prior to processing. For example, high yield hesperaloe pulps are generally prepared without pretreatment of the fiber with an aqueous solution of sodium sulfite, or the like, which is commonly employed in the manufacture of chemi-mechanical wood pulps.

In addition to hesperaloe pulp fibers, the tissue products may include one or more papermaking fibers such fibers derived from recycling of wastepaper, cellulosic fibers such as cotton linters, rayon, lyocell and bagasse non-wood pulp fibers and wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred. Pulps derived from both deciduous trees (hereinafter, also referred to as “hardwood”) and coniferous trees (hereinafter, also referred to as “softwood”) may be utilized.

Base tissue webs useful in the formation of tissue products of the present invention may be manufactured using any one of a number of well-known wet-laid papermaking processes that employ a creping step to foreshorten the web, such as, for example, creped wet pressed, modified wet pressed, or creped through-air dried (CTAD). In certain instances, basesheet may be formed using either a wet pressed or a modified wet pressed process such as those disclosed in U.S. Pat. Nos. 3,953,638, 5,324,575 and 6,080,279, the disclosures of which are incorporated herein in a manner consistent with the instant application. In these processes the embryonic tissue web is transferred to a Yankee dryer, which completes the drying process, and then creped from the Yankee surface using a doctor blade or other suitable device.

In other instances, the tissue basesheet may be manufactured by a creped through-air dried process in which the embryonic web is noncompressively dried. Suitable creped through-air dried processes include those disclosed in U.S. Pat. No. 10,240,296, the contents of which are incorporated herein in a manner consistent with the present disclosure.

In still other instances the tissue basesheet may be manufactured by a process including the step of using pressure, vacuum, or air flow through the wet web (or a combination of these) to conform the wet web into a shaped fabric and subsequently drying the shaped sheet using a Yankee dryer, or series of steam heated dryers, or some other means. Exemplary tissue manufacturing processes include, for example, ATMOS process developed by Voith or the NTT process developed by Metso; or fabric creped tissue, made using a process including the step of transferring the wet web from a carrying surface (belt, fabric, felt, or roll) moving at one speed to a fabric moving at a slower speed (at least 5 percent slower) and subsequently drying the sheet.

In one instance the manufacture of tissue basesheet comprising hesperaloe pulp fibers may be carried out using a twin wire former having a papermaking headbox that injects or deposits an aqueous suspension of papermaking fibers, including hesperaloe pulp fibers, onto a plurality of forming fabrics, such as the outer forming fabric and the inner forming fabric, thereby forming a wet tissue web. The forming process of the present disclosure may be any conventional forming process known in the papermaking industry. Such formation processes include, but are not limited to, Fourdriniers, roof formers such as suction breast roll formers, and gap formers such as twin wire formers and crescent formers.

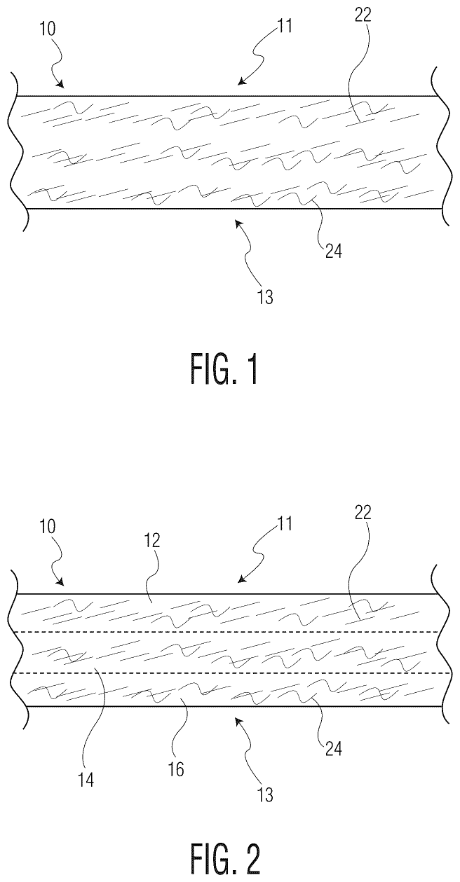

Tissue webs made in accordance with the present disclosure can be made with a homogeneous fiber furnish or can be formed from a stratified fiber furnish producing layers within the single- or multi-ply tissue product. Homogeneous webs, also referred to herein as blended, may be prepared such that the various fiber furnishes are distributed throughout the web, as illustrated in FIG. 1. As shown in FIG. 1, the web 10 may comprise a first outer surface 11 and second outer surface 13, one or more of the outer surfaces 10, 13 may be brought into contact with the user's skin during use depending upon how the web 10 is converted into a finished product. The web 10 further comprises a blend of hesperaloe pulp fibers 22 and wood pulp fibers 24. The homogenous nature of the fiber furnish is such that the hesperaloe pulp fibers 22 form a portion of the first outer surface 11 and second outer surface 13.

The inventive tissue products may also comprise a stratified web, which may be formed using equipment known in the art, such as a multi-layered headbox. Different fiber furnishes can be used in each layer in order to create a layer with the desired characteristics, however, it may be desirable to distribute the hesperaloe pulp fibers in two or more layers, particularly the layers forming the outer surfaces of the web. For example, as illustrated in FIG. 2 the tissue web 10 may comprises a first outer surface 11 and second outer surface 13 and first and second outer layers, 12, 16 and a middle layer 14. The first outer layer 12 and a second outer layer 16 both contain hesperaloe pulp fibers 22 and wood pulp fibers 24. The middle layer 14 may also contain hesperaloe pulp fibers 22 and wood pulp fibers 24.

When constructing a web from a stratified fiber furnish, the relative weight of each layer may vary. For example, in one instance, when constructing a web containing three layers, each layer can be from about 15 to about 40 percent of the total weight of the web, such as from about 25 to about 35 percent of the weight of the web. Hesperaloe pulp fibers 22 may comprise from about 5 wt % to about 50 wt % of the total weight of the web and may be disposed in the first and second outer layers or may be disposed in the each of the layers in an equal amount.

Although in certain instances the papermaking fibers may be deposited in layers to provide a stratified web, the inventors have now discovered that layer is not necessary to produce tissue products having desirable properties. Accordingly, in certain instances, it may be preferable to deposit hesperaloe pulp fibers throughout the web. In those instances, where a stratified headbox is used to form the web, hesperaloe pulp fibers may be deposited in two or more, or all of, the layers. In other instances, the web may not be stratified and may simply consist of hesperaloe and wood pulp fibers, such as hardwood kraft pulp fibers, blended together. Thus, in certain instances the hesperaloe pulp fibers may be distributed throughout the web, including the outer surface of the web.

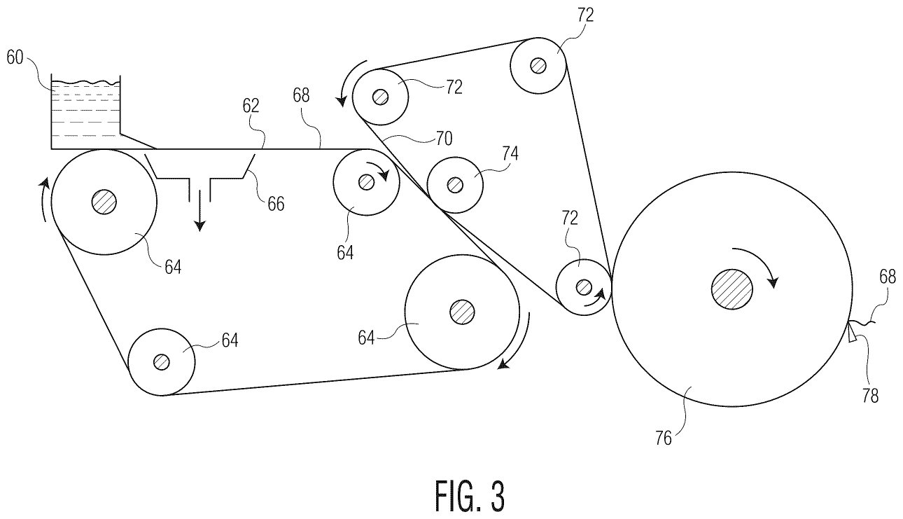

An exemplary means of manufacturing a tissue web according to the present invention is illustrated in FIG. 3. In the wet pressed creped tissue process of FIG. 3, is a headbox 60 emits an aqueous suspension of fibers onto a forming fabric 62 which is supported and driven by a plurality of guide rolls 64. The wet tissue web forms on the inner forming fabric as the inner forming fabric revolves about a forming roll. The inner forming fabric serves to support and carry the newly formed wet tissue web downstream in the process as the wet tissue web is partially dewatered to a consistency of about 10 percent based on the dry weight of the fibers.

A vacuum box 66 is disposed beneath forming fabric 62 and is adapted to remove water from the fiber furnish to assist in forming a web. Additional dewatering of the wet tissue web may be carried out by known paper making techniques, such as vacuum suction boxes, while the inner forming fabric supports the wet tissue web. The wet tissue web may be additionally dewatered to a consistency of greater than 20 percent, more specifically between about 20 to about 40 percent, and more specifically about 20 to about 30 percent.

From forming fabric 62, a formed web 68 is transferred to a second fabric 70, which may be either a wire or a felt. Fabric 70 is supported for movement around a continuous path by a plurality of guide rolls 72. Also included is a pick up roll 74 designed to facilitate transfer of web 68 from fabric 62 to fabric 70. From fabric 70, web 68, in this embodiment, is transferred to the surface of a rotatable heated dryer drum 76, such as a Yankee dryer.

Preferably the formed web is dried by transfer to the surface of a rotatable heated dryer drum, such as a Yankee dryer. In accordance with the present disclosure, the creping composition may be applied topically to the tissue web while the web is traveling on the fabric or may be applied to the surface of the dryer drum for transfer onto one side of the tissue web. In this manner, the creping composition is used to adhere the tissue web to the dryer drum. In this embodiment, as the web is carried through a portion of the rotational path of the dryer surface, heat is imparted to the web causing most of the moisture contained within the web to be evaporated. The web is then removed from the dryer drum by a creping blade. Creping the web, as it is formed, further reduces internal bonding within the web and increases softness. Applying the creping composition to the web during creping, on the other hand, may increase the strength of the web.

To achieve the desired creping efficiency and tissue product properties, tissue webs may be creped using a conventional creping composition comprising at least one, and more preferably at least two, water-soluble polymers. For purposes herein, “water-soluble” means that the polymers dissolve completely in water to give a solution as opposed to a latex, dispersion, or suspension of undissolved particles. Suitable water soluble polymers may be selected from the group consisting of polyamidoamine-epichlorohydrin resin, polyamine-epichlorohydrin resin, polyvinyl alcohol, polyvinylamine, polyethyleneimine, polyacrylamide, polymethacrylamide, poly(acrylic acid), poly(methacrylic acid), poly(hydroxyethyl acrylate), poly(hydroxyethyl methacrylate), poly(n-vinyl pyrrolidinone), poly(ethylene oxide), hydroxyethyl cellulose, hydroxypropyl cellulose, guar gum, starch, agar, chitosan, alginic acid, carboxymethyl cellulose, highly branched polyamidoamines and their reaction product with epichlorohydrin and silyl-linked polyamidoamines.

In one embodiment the conventional creping composition comprises a water-soluble polymer such as an aqueous solution comprising a polyether, a polyamide, or a mixture of one or both with another water-soluble polymer. Suitable polyethers include (poly)ethylene oxide, (poly)propylene oxide, ethylene oxide/propylene oxide copolymers, (poly)tetra methylene oxide, poly vinyl methyl ether, and the like. Suitable polyamides include (poly)vinylpyrrolidone, (poly)ethyl oxazoline, (poly)amidoamine, (poly)acrylamide, polyethylene imine, and the like. Number of average molecular weights for these components should be from about 10,000 to about 500,000.

Other water-soluble polymers which can be mixed with either of the water-soluble polymeric components used to form the creping composition include polyvinyl alcohol (PVOH), carboxymethylcellulose, hydroxypropyl cellulose, and the like.

As an option, creping adhesive compositions can be applied to the Yankee surface as the sole active agent, or optionally with a release aid, and further optionally with a phosphate donor or other additives and resins, through the same spray boom or other coating applicator. As an option, creping adhesives alone or in combination with release agents can be applied to the surface of the dryer in order to provide the appropriate adhesion to produce the desired crepe. As generally understood, the adhesive portion and any release aids used in the coating composition may migrate differentially as between a hot Yankee surface and the opposite web surface.

In a particularly preferred embodiment the creping composition comprises a creping adhesive component and a release component, both of which may be a water soluble cationic polyamide-epihalohydrin, which is the reaction product of an epihalohydrin and a polyamide containing secondary amine groups or tertiary amine groups. Commercially available polyamide-epihalohydrins are sold under the trade names including Kymene™, Crepetrol™, and Rezosol™ (Solenis LLC, Wilmington, DE, U.S.A). and Bubond™ (Buckman Laboratories International Inc., Memphis, TN, USA). Suitable adhesive agents include, for example, polyamidoamine epichlorohydrin polymers, such as those sold under the trade name Crepetrol™, such as Crepetrol™ A2320. Suitable release agents include, for instance, polyamidoamine epichlorohydrin polymers, such as those sold under the trade name Rezosol™. Particular release agents that may be used in the present disclosure include and Bubond™ series release agents, such Bubond™ 2062, Bubond™ 2624 (commercially available from Buckman Laboratories International Inc., Memphis, Tenn. USA). In certain embodiments the adhesive agent is added to the dryer at higher levels than the release agent, such that the ratio of adhesive agent to release agent (on a mass basis) is from about 2:1 to about 2:1.5.

In certain instances, a layer or other portion of the web, including the entire web, can be provided with wet or dry strength agents. As used herein, “wet strength agents” are materials used to immobilize the bonds between fibers in the wet state. Any material that when added to a paper web or sheet at an effective level results in providing the sheet with a wet geometric tensile strength:dry geometric tensile strength ratio in excess of 0.1 will, for purposes of this invention, be termed a wet strength agent. Typically, these materials are termed either as permanent wet strength agents or as “temporary” wet strength agents. For the purposes of differentiating permanent from temporary wet strength, permanent will be defined as those resins which, when incorporated into paper or tissue products, will provide a product that retains more than 50 percent of its original wet tensile strength after exposure to water for a period of at least five minutes. permanent wet strength agents are those which show less than 50 percent of their original wet strength after being saturated with water for five minutes. Both classes of material find application in the present invention. The amount of wet strength agent or dry strength added to the pulp fibers can be at least about 0.1 dry weight percent, more specifically about 0.2 dry weight percent or greater, and still more specifically from about 0.1 to about 3 dry weight percent, based on the dry weight of the fibers.

Useful dry strength additives include carboxymethyl cellulose resins, starch-based resins, and mixtures thereof. Examples of preferred dry strength additives include naturally derived starches, carboxymethyl cellulose and cationic modified starches such as those commercially available under the tradename REDIBOND™ (Ingredion Inc., Westchester, IL, U.S.A.).

Suitable temporary wet strength resins include, but are not limited to, polyacrylamide resins, particularly glyoxyalated polyacrylamide resins and still more particularly cationic glyoxyalated polyacrylamide resins. Suitable temporary wet strength resins are described in U.S. Pat. Nos. 3,556,932 and 3,556,933. Useful temporary wet strength agents include those commercially available under the tradename FennoBond™ (Solenis LLC, Wilmington, DE, U.S.A).

In certain instances, particularly in the manufacture of facial tissue and paper towels that may require to have a degree of tensile strength when wet, it may be preferable to manufacture the base web using a permanent wet strength agents. Permanent wet strength agents are also well known in the art and provide a product that will retain more than 50% of its original wet strength after exposure to water for a period of at least 5 minutes. Suitable permanent wet strength agents may include polyamide-epichlorohydrin, polyacrylamides, styrene-butadiene latices; insolubilized polyvinyl alcohol; urea-formaldehyde; polyethyleneimine; chitosan polymers and mixtures thereof can be added to the papermaking furnish or to the embryonic web. Suitable types of such resins are described in U.S. Pat. Nos. 3,700,623 and 3,772,076. Particularly preferred permanent wet strength agents may be polyamide-epichlorohydrin resins, such as those available the tradename Kymene™ (Solenis LLC, Wilmington, DE, U.S.A).

Although wet and dry strength agents as described above find particular advantage for use in connection with this invention, other types of bonding agents can also be used to provide the necessary wet resiliency. They can be applied at the wet end of the basesheet manufacturing process or applied by spraying or printing after the basesheet is formed or after it is dried.

In other instances, the web or one or more layers of a stratified web, may be formed without a substantial amount of inner fiber-to-fiber bond strength. In this regard, the fiber furnish may be treated with a chemical debonding agent. The debonding agent can be added to the fiber slurry during the pulping process or can be added directly into the headbox. Suitable debonding agents that may be used in the present invention include cationic debonding agents, particularly quaternary ammonium compounds, mixtures of quaternary ammonium compounds with polyhydroxy compounds, and modified polysiloxanes.

Suitable cationic debonding agents include, for example, fatty dialkyl quaternary amine salts, mono fatty alkyl tertiary amine salts, primary amine salts, imidazoline quaternary salts, silicone quaternary salt and unsaturated fatty alkyl amine salts. Other suitable debonding agents are disclosed in U.S. Pat. No. 5,529,665, the contents of which are incorporated herein in a manner consistent with the present disclosure. Particularly preferred debonders may comprise an organic quaternary ammonium chloride and particularly a silicone-based amine salt of a quaternary ammonium chloride. Useful debonders are commercially available under the tradename ProSoft™ (commercially available from Solenis LLC, Wilmington, DE, U.S.A). The debonding agent can be added to the fiber slurry in an amount of from about 1.0 kg per metric tonne to about 15 kg per metric tonne of fibers present within the slurry.

Particularly useful quaternary ammonium debonders include imidazoline quaternary ammonium debonders, such as oleyl-imidazoline quaternaries, dialkyl dimethyl quaternary debonders, ester quaternary debonders, diamidoamine quaternary debonders, and the like. The imidazoline-based debonding agent can be added in an amount of between 1.0 to about 10 kg per metric tonne.

Tissue webs, prepared as described above, may be incorporated into tissue products comprising a single ply or multiple plies, such as two, three or four plies. The products may be subjected to further processing including, but not limited to, printing, embossing, calendering, slitting, folding, combining with other fibrous structures, and the like. The tissue webs may be converted into anyone of several tissue products particularly paper towels, napkins, industrial wipers, and the like.

Once formed, the products may be packaged in different ways. For instance, in one embodiment, the sheet-like product may be cut into individual sheets and stacked prior to being placed into a package. Alternatively, the sheet-like product may be spirally wound. When spirally wound together, each individual sheet may be separated from an adjacent sheet by a line of weakness, such as a perforation line. Bath tissues and paper towels, for instance, are typically supplied to a consumer in a spirally wound configuration.

The instant multi-ply tissue product may be constructed from two or more plies that are manufactured using the same or different tissue making techniques. For example, the inventive tissue products may comprise two thorough-air dried tissue plies where each ply has a basis weight greater than about 20 gsm, such as from about 20 to about 50 gsm, such as from about 22 to about 30 gsm, where the Plies have been attached to one another by a glue laminating embossing process which provides the tissue product with an embossing pattern on at least one of its outer surfaces.

Regardless of how the basesheet is converted to tissue products, the products of the present invention generally comprise at least about 5 percent, such as at least about 10 percent, such as at least about 15 percent, such as at least about 20 percent, such as at least about 25 percent, such as at least about 30 percent, such as from about 5 to about 50 percent, such as from about 7.5 to about 45 percent, such as from about 10 to about 40 percent hesperaloe pulp fiber.

Preferably the hesperaloe pulp is a high yield hesperaloe pulp and more preferably a high yield hesperaloe pulp having a low degree of pulp debris. As such, tissue products produced with hesperaloe pulp preferably have a low degree of Product Debris, such as about 1.0% or less Product Debris, such as about 0.75% or less, such as about 0.50% or less, such as about 0.25% or less, such as from about 0.05% to about 1.0%. The low degree of Product Debris generally yields a tissue product having improved surface properties, such as improved TS7 and TS750, and improves the processing of the tissue web during manufacture.

Hesperaloe pulp fiber may replace all or a portion of the long wood pulp fiber fraction of the papermaking furnish, such as NSWK or SSWK. Accordingly, in certain instances, the tissue products may comprise less than about 25 wt % NSWK or SSWK, such as less than about 15 wt % NSWK or SSWK, such as less than about 15 wt % NSWK or SSWK. In certain instances, hesperaloe pulp fiber may replace all of the long wood pulp fibers of the papermaking furnish such that the tissue product is substantially free from, and in certain instances free from, long wood pulp fibers such as NSWK or SSWK.

In certain instances, the inventive tissue products may comprise two or more plies and have a GMT greater than about 600 g/3″, such as about 650 or greater, such as about 700 g/3″ or greater, such as about 750 g/3″ or greater, such about 800 g/3″ or greater, such as about 850 g/3″ or greater, such as about 900 g/3″ or greater, such as about 1,000 g/3″ or greater, such as about 1,100 g/3″ or greater, such as from about 600 g/3″ to about 1,750 g/3″, such as from about 750 g/3″ to about 1,250 g/3″, such as from about 800 to about 1,100 g/3″.

In other instances, the inventive tissue products may comprise a single ply and have a GMT from about 500 g/3″ to about 1,000 g/3″, such as from about 550 g/3″ to about 850 g/3″.

The tissue products of the present invention may have a basis weight of from about 15 gsm to about 120 gsm, such as from about 15 gsm to about 110 gsm, such as from about 20 to about 100 gsm, such as from about 30 to 90 gsm, such as from about 35 to about 50 gsm. In certain instances, the tissue products may comprise a single tissue ply product and may have a basis weight from about 15 gsm to about 30 gsm. In other instances, the tissue products may comprise two or more plies, such as two, three or four tissue plies and may have a basis weight from about 30 gsm to about 60 gsm, such as from about 40 gsm to about 50 gsm.

The tissue products of the present invention may have a sheet bulk of about 10 cc/g or greater, such as about 12 cc/g or greater, such as about 14 cc/g or greater, such as about 16 cc/g or greater, such as from about 10 cc/g to about 20 cc/g, such as from about 10 cc/g to about 16 cc/g, such as from about 12 cc/g to about 16 cc/g.

The tissue products of the present invention are generally soft and have a moderate degree of strength. As such, the tissue products may have a TS7 value of about 15.0 or less, such as about 14.0 or less, such as about 13.0 or less, such as about 12.0 or less, such as about 11.0 or less, such as about 10.5 or less, such as from about 9.0 to about 15.0, such as from about 10.0 to about 14.0. The foregoing levels of softness may be achieved at tensile strengths (measured as GMT) from about 500 g/3″ to about 1,750 g/3″, such as from about 550 g/3″ to about 1,250 g/3″, such as from about 600 to about 1,100 g/3″.

In other instances, the tissue products of the present invention may comprise two or more creped tissue plies and have a TS7 value equal or less than 0.0061(GM)+5.7777 where GMT is the geometric mean tensile strength of the tissue product having units of grams per three inches and the GMT of the tissue products ranges from about 600 g/3″ to about 1,750 g/3″, such as from about 750 g/3″ to about 1,250 g/3″, such as from about 800 to about 1,100 g/3″.

In other instances, the tissue products of the present invention may comprise a single creped tissue ply and have a TS7 value equal or less than 0.0119(GMT)+6.6187 where GMT is the geometric mean tensile strength of the tissue product having units of grams per three inches. The geometric mean tensile strength of the single ply tissue products may range

Although the tissue products of the present invention are soft and have a modest degree of tensile strength, the products have a surprisingly high degree of durability. For example, the tissue products may have a Durability Index of about 30 or greater, such as about 32 or greater, such as about 34 or greater, such as about 36 or greater, such as about 38 or greater, such as from about 30 to about 60, such as from about 32 to about 58, such as from about 35 to about 55. The foregoing Durability Index levels may be achieved despite the products having a modest degree of tensile strength, such as a GMT from about 500 g/3″ to about 1,750 g/3″, such as from about 550 g/3″ to about 1,250 g/3″, such as from about 600 to about 1,100 g/3″.

In other instances, the tissue products have a Stiffness Index of about 10.0 or less, such as less than about 9.0, such as less than about 8.0, such as less than about 7.0, such as from about 5.0 to about 10.0, such as from about 6.0 to about 9.0. The tissue products may have a low degree of stiffness, such as a Stiffness Index from about 5.0 to about 10.0, and a relatively high degree of durability, such as a Durability Index of about 30 or greater, such as about 32 or greater, such as about 34 or greater, such as about 36 or greater, such as about 38 or greater, such as from about 30 to about 60, such as from about 32 to about 58, such as from about 35 to about 55.

### Test Methods

### Fiber Properties

Fiber properties such as length, coarseness, percentage of fines, and fraction of very long fiber, are generally determined using an OpTest Fiber Quality Analyzer-360 (OpTest Equipment, Inc., Hawkesbury, ON) in accordance with the manufacturer's instructions. Samples are generally prepared by first accurately weighing a pulp sample. The sample mass may range from about 10 to about 50 mg (bone dry) and may be taken from a handsheet or pulp sheet. The weighed sample is diluted to a known consistency (between about 2 and about 10 mg/I). An aliquot of the diluted sample (usually 200 ml) is further diluted to a final volume of 600 ml and placed in the analyzer. The sample is then analyzed according to the manufacturer's instructions and the output of the analyzer, such as the length weighted average fiber length, coarseness, length weighted fines, and a histogram illustrating the distribution of various fiber properties for a given sample are recorded. Generally, each reported fiber property is the average of three replicates.

The output of the fiber quality analyzer is used to calculate the Very Long Fiber (VFL) fraction, which is the sum of fiber count from 6 to 14.95 mm divided by the total fiber count. Generally, the bin data output by the instrument, which provides the number of individual fibers counted within a given fiber length range, is used to determine VLF. The total number of individual fibers counted (N) and the total number of individual fibers counted having a length of 6 mm or greater (n) are determined from the bin data. The % VLF=n/N*100.

The output of the fiber quality analyzer is also used to calculate the ratio of the length weighted average fiber length (L_{w}) to the number average fiber length (Lₙ). L_{w} and Lₙ are calculated by the FQA software using the following equations:

$${L}_{w} = \frac{{\sum }_{All Fibers} {n}_{i} {L}_{i}^{2}}{{\sum }_{All Fibers} {n}_{i} {L}_{i}} \qquad {L}_{n} = \frac{{\sum }_{All Fibers} {n}_{i} {L}_{i}}{{\sum }_{All Fibers} {n}_{i}}$$

Where n and L are determined by the instrument in the course of analyzing a sample. The ratio of the length weighted average fiber length (L_{w}) to the number average fiber length (Lₙ) indicates the fiber length distribution of the sample. A higher ratio is indicative of a broader fiber length distribution. A value of 1 indicates that all of the fibers in the sample have the same length.

Fiber coarseness is measured using the FQA instrument and is measured “as-is” without removal of fines. Consistency of the pulp sample is determined using TAPPI methods T-240 or the equivalent and the consistency (%) is recorded to the nearest 0.01%. Based upon the measured consistency, the amount of undried sample required to yield approximately 0.015 grams of oven dried pulp is calculated and weighed out and the weight recorded to the nearest 0.0001 g. The weighed undried pulp is transferred to a British pulp disintegrator or equivalent pulp disintegrator and the total volume of the sample is diluted to 2 liters with deionized water and disintegrated 15,000 revolutions according to the manufacturer's instructions. The disintegrated sample is further diluted with deionized water to a total volume of 5 liters±50 mL and the volume is recorded to the nearest 10 mL. The diluted sample is agitated by stirring and approximately 600 grams are weighted out into a clean beaker. The mass of the sample weighed out to the beaker is recorded to the nearest 0.1 g. The oven dried weight of the pulp sample to be analyzed is then calculated as shown in the equation below and fiber analysis is carried out according to the manufacturer's instructions.

$$O . D . Mass of Pulp ( g ) = \frac{\begin{matrix}Undried Pulp ( g ) \times Consistency of \\ undried sample ( \% ) \times Mass of Sample ( g )\end{matrix}}{Diluted Sample Volume ( mL ) \times 10}$$

### Product Debris

Unlike wood pulp sources which have an easy to remove cambium layer, hesperaloe has a thick waxy outer cuticle that cannot be removed prior to pulping. As a result, the cuticle is carried through the pulping process and must be removed during cleaning of the pulp. If the cuticle is not it may be deposited on the outer surface of the web where it can interfere with the manufacturing process and degrade the quality of the tissue product. To quantify the amount of cuticle, herein referred to as Product Debris, in the finished product a staining and quantitative method has been developed. The cuticle is stained using an Oil Red O Stain, which is mixing 40 mL of Oil Red O Stain in Isopropanol (commercially available from Sigma-Aldrich, St. Lous, MO, U.S.A.) and 60 mL of 100% 40 mL Isopropanol ACS, 100%. A 4 inch×4 inch square of the tissue product is cut and placed in a sealable container large enough to hold the product flat and be fully submerged. The Oil Red O Stain solution is added to the container under the sample is submerged. The container is sealed and the sample is allowed to stand for 4 hours. The sample is washed gently using several changes of Isopropanol ACS, 100% no bleeding of residual stain is observed. The sample is then air dried.

The stained and dried sample is then analyzed using a DFC 300 camera fitted with a 40 mm adjustable El Nikkor lens (f/4) and transverse lighting. Image capture and analysis is then performed as follows:

```
Enter Results Header
  File Results Header (channel #1)
  File Line (channel #1)
  File Line (channel #1)
  Image frame (x 0, y 0, Width 1392, Height 1040)
  Measure frame (x 31, y 61, Width 1330, Height 978)
  CALVALUE = 0.0255
  Calibration (Local)
  Pause Text (“Set-up sample for imaging”)
  Image Setup DC Twain [PAUSE] (Camera 1, AutoExposure Off, Gain 0.00, ExposureTime
120.01 msec, Brightness 0, Lamp 49.99)
  PauseText (“Enter image file prefix name.”)
  Input (TITLE$)
  For (SAMPLE = 1 to 1, step 1)
    STAGE MOTION
    Stage (Define Origin)
    Stage (Scan Pattern, 3 × 3 fields, size 22500.000000 × 16800.000000)
    IMAGE ACQUIRE AND DETECTION
    For (STAGE = 1 to 9, step 1)
      IMAGE = IMAGE+1
      ACQOUTPUT = 0
      Clear Accepts
      Image Setup DC Twain (Camera 1, AutoExposure Off, Gain 0.00, ExposureTime 120.01
msec, Brightness 0, Lamp 49.99)
      Acquire (into Colour0)
      Colour Transform (RGB to HSI, from Colour0 to Colour0)
      ACQFILE$ = “D:\Images\03665 - Kyker\“+TITLE$+”_“+STR$(IMAGE)+”.TIF”
      Write image (from ACQOUTPUT into file ACQFILE$)
      Colour Detect (HSI+: 37-140, 60-179, 39-110, from Colour0 into Binary0)
      IMAGE PROCESSING
      Binary Amend (Close from Binary0 to Binary1, cycles 2, operator Disc, edge erode on)
      Binary Amend (Open from Binary1 to Binary2, cycles 1, operator Disc, edge erode on)
      Binary Amend (Close from Binary2 to Binary3, cycles 3, operator Disc, edge erode on)
      PauseText (“Remove extraneously detected regions.”)
      Binary Edit [PAUSE] (Reject from Binary3 to Binary4, nib Fill, width 2)
      FIELD MEASUREMENTS - Count and area
      Measure field (plane Binary4)
        Selected parameters: Area, Count, Area%, Count/Area
      Display Field Results (x 1431, y 698, w 474, h 359)
      File Field Results (channel #1)
      FEATURE MEASUREMENT - Nit Size
      Measure feature (plane Binary4, 8 ferets, minimum area: 40, grey image: Colour0)
        Selected parameters: Area, X FCP, Y FCP
      Feature Histogram #1 (Y Param Number, X Param Area, from 9.999999776e−003 to 10.,
logarithmic, 20 bins)
      Display Feature Histogram Results (#1, horizontal, differential, bins + graph (Y axis linear),
statistics)
        Data Window (1346, 283, 540, 448)
      Stage (Step, Wait until stopped + 55 msecs)
    Next (STAGE)
    Pause Text (“Position next replicate for analysis.”)
    Image Setup DC Twain [PAUSE] (Camera 1, AutoExposure Off, Gain 0.00, ExposureTime
120.01 msec, Brightness 0, Lamp 49.99)
  Next (SAMPLE)
  DATA OUTPUT
  File Line (channel #1)
  File Line (channel #1)
  File Line (channel #1)
  File (“Nit Size Distribution (mm2)”, channel #1)
  File Line (channel #1)
  File Feature Histogram Results (#1, differential, statistics, bin details, channel #1)
  CLOSE DATA FILES
  Close File (channel #1)
  END
```

### Basis Weight

Basis weight of sample is measured by selecting twelve (12) products (also referred to as sheets) of the sample and making two (2) stacks of six (6) sheets. In the event the sample consists of perforated sheets of bath or towel tissue, the perforations must be aligned on the same side when stacking the usable units. A precision cutter is used to cut each stack into exactly 10.16×10.16 cm (4.0×4.0 inch) squares. The two stacks of cut squares are combined to make a basis weight pad of twelve (12) squares thick.

The basis weight pad is then placed in the uncovered container and the container with sample is placed in a 105±2 °C oven for an hour. After an hour, the lid is placed on the container and the container is removed from the oven and allowed to cool to approximately room temperature.

The covered container with sample is then weighed on a top loading balance with a minimum resolution of 0.01 grams. The top loading balance must be protected from air drafts and other disturbances using a draft shield. Weights are recorded when the readings on the top loading balance become constant. The weight of the container and lid are subtracted to determine the sample weight in grams. The mass of the sample (grams) per unit area (square meters) is calculated and reported as the basis weight, having units of grams per square meter (gsm).

### Caliper

Caliper is measured in accordance with TAPPI test methods Test Method T 580 pm-12 “Thickness (caliper) of towel, tissue, napkin and facial products.” The micrometer used for carrying out caliper measurements is an Emveco 200-A Tissue Caliper Tester (Emveco, Inc., Newberg, OR). The micrometer has a load of 2 kilo-Pascals, a pressure foot area of 2,500 square millimeters, a pressure foot diameter of 56.42 millimeters, a dwell time of 3 seconds and a lowering rate of 0.8 millimeters per second.

### Burst Strength (Wet or Dry)

Burst Strength is measured using an EJA Burst Tester (series #50360, commercially available from Thwing-Albert Instrument Company, Philadelphia, PA). The test procedure is according to TAPPI T570 pm-00 except the test speed. The test specimen is clamped between two concentric rings whose inner diameter defines the circular area under test. A penetration assembly, the top of which is a smooth, spherical steel ball, is arranged perpendicular to and centered under the rings holding the test specimen. The penetration assembly is raised at 6 inches per minute such that the steel ball contacts and eventually penetrates the test specimen to the point of specimen rupture. The maximum force applied by the penetration assembly at the instant of specimen rupture is reported as the burst strength in grams force (gf) of the specimen.

The penetration assembly consists of a spherical penetration member which is a stainless-steel ball with a diameter of 0.625±0.002 inches (15.88±0.05 mm) finished spherical to 0.00004 inches (0.001 mm). The spherical penetration member is permanently affixed to the end of a 0.375±0.010 inch (9.525±0.254 mm) solid steel rod. A 2000 gram load cell is used and 50 percent of the load range i.e., 0-1000 g is selected. The distance of travel of the probe is such that the upper most surface of the spherical ball reaches a distance of 1.375 inches (34.9 mm) above the plane of the sample clamped in the test. A means to secure the test specimen for testing consisting of upper and lower concentric rings of approximately 0.25 inches (6.4 mm) thick aluminum between which the sample is firmly held by pneumatic clamps operated under a filtered air source at 60 psi. The clamping rings are 3.50±0.01 inches (88.9±0.3 mm) in internal diameter and approximately 6.5 inches (165 mm) in outside diameter. The clamping surfaces of the clamping rings are coated with a commercial grade of neoprene approximately 0.0625 inches (1.6 mm) thick having a Shore hardness of 70-85 (A scale). The neoprene needs not cover the entire surface of the clamping ring but is coincident with the inner diameter, thus having an inner diameter of 3.50±0.01 inches (88.9±0.3 mm) and is 0.5 inches (12.7 mm) wide, thus having an external diameter of 4.5±0.01 inches (114±0.3 mm). For each test a total of 3 sheets of product are combined.

The sheets are stacked on top of one another in a manner such that the machine direction of the sheets is aligned. Where samples comprise multiple plies, the plies are not separated for testing. In each instance the test sample comprises 3 sheets of product. For example, if the product is a 2-ply tissue product, 3 sheets of product, totaling 6 plies are tested. If the product is a single ply tissue product, then 3 sheets of product totaling 3 plies are tested.

Samples are conditioned under TAPPI conditions for a minimum of four hours and cut into 127×127±5 mm squares. For wet burst measurement, after conditioning the samples were wetted for testing with 0.5 mL of deionized water dispensed with an automated pipette. The wet sample is tested immediately after insulting.

The peak load (gf) and energy to peak (g-cm) are recorded and the process repeated for all remaining specimens. A minimum of five specimens are tested per sample and the peak load average of five tests is reported.

### Tear

Tear testing was carried out in accordance with TAPPI test method T-414 “Internal Tearing Resistance of Paper (Elmendorf-type method)” using a falling pendulum instrument such as Lorentzen & Wettre Model SE 009. Tear strength is directional, and MD and CD tear are measured independently.

More particularly, a rectangular test specimen of the sample to be tested is cut out of the tissue product or tissue base sheet such that the test specimen measures 63±0.15 mm (2.5±0.006 inches) in the direction to be tested (such as the MD or CD direction) and between 73 and 114 mm (2.9 and 4.6 inches) in the other direction. The specimen edges must be cut parallel and perpendicular to the testing direction (not skewed). Any suitable cutting device, capable of the prescribed precision and accuracy, can be used. The test specimen should be taken from areas of the sample that are free of folds, wrinkles, crimp lines, perforations or any other distortions that would make the test specimen abnormal from the rest of the material.

The number of plies or sheets to test is determined based on the number of plies or sheets required for the test results to fall between 20 to 80 percent on the linear range scale of the tear tester and more preferably between 20 to 60 percent of the linear range scale of the tear tester. The sample preferably should be cut no closer than 6 mm (0.25 inch) from the edge of the material from which the specimens will be cut. When testing requires more than one sheet or ply the sheets are placed facing in the same direction.

The test specimen is then placed between the clamps of the falling pendulum apparatus with the edge of the specimen aligned with the front edge of the clamp. The clamps are closed, and a 20-millimeter slit is cut into the leading edge of the specimen usually by a cutting knife attached to the instrument. For example, on the Lorentzen & Wettre Model SE 009 the slit is created by pushing down on the cutting knife lever until it reaches its stop. The slit should be clean with no tears or nicks as this slit will serve to start the tear during the subsequent test.

The pendulum is released and the tear value, which is the force required to completely tear the test specimen, is recorded. The test is repeated a total of ten times for each sample and the average of the ten readings reported as the tear strength. Tear strength is reported in units of grams of force (gf). The average tear value is the tear strength for the direction (MD or CD) tested. The “geometric mean tear strength” is the square root of the product of the average MD tear strength and the average CD tear strength. The Lorentzen & Wettre Model SE 009 has a setting for the number of plies tested. Some testers may need to have the reported tear strength multiplied by a factor to give a per ply tear strength. For base sheets intended to be multiple ply products, the tear results are reported as the tear of the multiple ply product and not the single ply base sheet. This is done by multiplying the single ply base sheet tear value by the number of plies in the finished product. Similarly, the tear strength of products comprising multiple plies is reported as the tear strength for the finished product sheet and not the individual plies. A variety of means can be used to calculate but in general will be done by inputting the number of sheets to be tested rather than the number of plies to be tested into the measuring device. For example, two sheets would be two 1-ply sheets for 1-ply product and two 2-ply sheets (4-plies) for 2-ply products.

### Tensile

Tensile testing is conducted on a tensile testing machine maintaining a constant rate of elongation and the width of each specimen tested is 3 inches. Testing is conducted under TAPPI conditions. Prior to testing samples are conditioned under TAPPI conditions (23±1 °C and 50±2 percent relative humidity) for at least 4 hours and then cutting a 3±0.05 inches (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full-scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength having units of grams per three inches (g/3″). Tensile energy absorbed (TEA) and slope are also calculated by the tensile tester. TEA is reported in units of g·cm/cm² and slope is recorded in units of kilograms (kg). Both TEA and Slope are directionally dependent and thus MD and CD directions are measured independently.

All products were tested in their product forms without separating into individual plies. For example, a 2-ply product was tested as two plies and recorded as such. In the tensile properties of basesheets were measured, the number of plies used varied depending on the intended end use. For example, if the basesheet was intended to be used for 2-ply product, two plies of basesheet were combined and tested.

### Tissue Softness Analyzer

Softness was measured using an EMTEC Tissue Softness Analyzer (“TSA”) (Emtec Electronic GmbH, Leipzig, Germany), calibrated according to the manufacturer's instructions. The TSA comprises a rotor with vertical blades which rotate on the tissue sample applying a defined contact pressure. The blades are pressed against the sample with a load of 100 mN and the rotational speed of the blades is two revolutions per second. Contact between the vertical blades and the tissue sample creates vibrations, which are sensed by a vibration sensor. The sensor then transmits a signal to a PC for processing and display. The signal is displayed as a frequency spectrum. The frequency analysis in the range of approximately 200 to 1000 Hz represents the surface smoothness or texture of the sample. A high amplitude peak occurring between 200 to 1000 Hz correlates to a rougher surface and is reported as the TS750 value, having units of dB V2 rms. A further peak in the frequency range between 6 and 7 kHZ represents the softness of the sample. The peak in the frequency range between 6 and 7 kHZ is herein referred to as the TS7 value and is expressed as dB V2 rms. A high amplitude peak correlates to less soft surface, while a low amplitude peak correlates a softer surface.

Tissue product samples were prepared by cutting a circular sample having a diameter of 112.8 mm. All samples were allowed to equilibrate at TAPPI conditions for at least 24 hours prior to completing the TSA testing. After conditioning each sample was tested as-is, i.e., multi-ply products were tested without separating the sample into individual plies.

Samples are mounted into the instrument and the test is carried out according to the manufacturer's instructions. When complete, the TSA software displays values for TS7 and TS750. These values are recorded to the nearest 0.01 dB V2 rms. Once testing is complete, the sample is removed from the instrument and discarded. The test is performed on the top surface (outer facing surface of a rolled product) of five of the replicate samples, using a new sample for each test. The five test results are averaged and the average value is reported.

### EXAMPLE

### Example 1: Multiply Creped Facial Tissue Product

In this example, tissue webs were made generally according to the process illustrated in FIG. 3. High Yield Hesperaloe pulp (HYH) was produced by processing H. funifera using a high yield pulping process substantially as described in such as described in PCT Application No. PCT/US2021/058196 by cutting the biomass to size, extracting the water soluble solids and impregnating the cut and extracted fiber with an alkaline phosphate solution prior to refining. The pulping process had a yield of about 76%. The physical properties of the HYH pulp are summarized in Table 1, below. The HYH pulp was prepared by dispersing HYH pulp in a pulper for 30 minutes at a consistency of about 3 percent. The fiber was then transferred to a machine chest and diluted to a consistency of 1 percent. The HYH pulp was further diluted to a consistency ranging from about 0.5% before being pumped to the headbox.

TABLE 1

| Fiber Length | Coarseness | Very Long Fiber | Pulp Debris | Brightness |
|---|---|---|---|---|
| (mm) | (mg/100 m) | Fraction (%) | Content (%) | (%) |
| 1.75 | 4.5 | 0.05 | 1.0 | 82 |

In those instances where the web comprised NSWK, NSWK pulp was placed into a pulper and disintegrated for 15 minutes at 4% consistency. Then, the NSWK pulp was refined for 15 minutes, transferred to a dump chest and subsequently diluted to approximately 2% consistency. The NSWK pulp was pumped to a machine chest and further diluted to a consistency ranging from about 0.2-0.3% before being pumped to the headbox.

Eucalyptus hardwood kraft (EHWK) pulp was placed into a pulper and disintegrated for 30 minutes at about 4% consistency. The EHWK pulp was then transferred to a dump chest and subsequently diluted to about 2% consistency. Next, the EHWK pulp slurry was diluted and pumped at about 1% consistency into a machine chest. The pulp slurry was subsequently diluted to about 0.1% consistency and pumped through the headbox.

In all cases the base sheets were produced from various fiber furnishes including, EHWK pulp, NSWK pulp, and HYH. The furnishes were blended together before being pumped to stratified headbox, thus forming a blended tissue web. In certain instances, the blended fiber furnish was subjected to refining batch refining at 4.5 hp-days/metric ton for specified period of time as set forth in Table 1, below. In other instances, (Redibond™, commercially available from Ingredion Inc., Westchester, IL, U.S.A.) was added to the blended fiber furnish to control strength. The composition of the various tissue webs produced by this example are described in Table 1, below.

TABLE 1

| | EHWK | NSWK | HYH | Refining | Starch |
|---|---|---|---|---|---|
| Sample | (wt %) | (wt %) | (wt %) | (min.) | (kg/tonne) |
| 1 | 75 | 25 | — | 4 | — |
| 2 | 75 | 25 | — | 8 | — |
| 3 | 75 | 25 | — | 8 | 2.5 |
| 4 | 95 | — | 5 | 2 | — |
| 5 | 95 | — | 5 | 2 | 2.5 |
| 6 | 95 | — | 5 | 2 | 6.0 |
| 7 | 85 | — | 15 | 4 | — |
| 8 | 85 | — | 15 | 4 | 2.5 |
| 9 | 85 | — | 15 | 4 | 6.0 |
| 10 | 75 | — | 25 | 6 | — |
| 11 | 75 | — | 25 | 6 | 2.5 |
| 12 | 75 | — | 25 | 6 | 6.0 |

The fibers were deposited on a forming fabric. Water was subsequently removed by vacuum. The wet sheet, about 10-20% consistency, was transferred to a press felt or press fabric where it was further dewatered. The sheet was then transferred to a Yankee dryer through a nip via a pressure roll. The consistency of the wet sheet after the pressure roll nip (post-pressure roll consistency or PPRC) was approximately 40%. The wet sheet adhered to the Yankee dryer due to an adhesive that is applied to the dryer surface. Spray booms situated underneath the Yankee dryer sprayed either an adhesive package, which is a mixture of polyvinyl alcohol and Kymene™ (Solenis LLC, Wilmington, DE, U.S.A).

The sheet was dried to about 95% consistency as it traveled on the Yankee dryer and to the creping blade. The creping blade subsequently scraped the tissue sheet off the Yankee dryer. The creped tissue base sheet was then wound onto a 3″ core into soft rolls for converting. Two rolls of the creped tissue were then rewound and plied together so that both creped sides were on the outside of the 2-ply structure. Mechanical crimping on the edges of the structure held the plies together. The plied sheet was then slit on the edges to a standard width of approximately 8.5 inches and folded. The physical properties of the resulting tissue products are reported in Tables 2 and 3, below.

TABLE 2

| | Basis | | | | | Wet |
|---|---|---|---|---|---|---|
| | Weight | GMT | GM TEA | GM Slope | GM Tear | Burst |
| Sample | (gsm) | (g/3″) | (g · cm/cm²) | (kg) | (gf) | (gf) |
| 1 | 34.2 | 923 | 8.3 | 6.19 | 5.25 | 43.8 |
| 2 | 32.0 | 1181 | 11.9 | 8.61 | 6.96 | 47.3 |
| 3 | 32.7 | 1613 | 15.3 | 9.58 | 9.70 | 51.8 |
| 4 | 32.8 | 756 | 8.4 | 4.98 | 6.52 | 88.6 |
| 5 | 32.0 | 1181 | 11.8 | 8.35 | 8.82 | 88.3 |
| 6 | 31.3 | 1647 | 15.5 | 12.61 | 10.21 | 97.1 |
| 7 | 32.4 | 881 | 7.5 | 7.00 | 5.27 | 58.5 |
| 8 | 31.8 | 1289 | 10.4 | 10.17 | 7.09 | 58.1 |
| 9 | 31.3 | 1678 | 12.6 | 13.30 | 9.00 | 64.8 |
| 10 | 32.9 | 753 | 6.0 | 5.07 | 3.67 | 36.0 |
| 11 | 31.6 | 977 | 8.4 | 8.05 | 5.36 | 41.8 |
| 12 | 30.8 | 1285 | 10.4 | 10.69 | 6.52 | 39.0 |

TABLE 3

| | | Sheet | | | | |
|---|---|---|---|---|---|---|
| | Caliper | Bulk | Slough | Stiffness | | |
| Sample | (μm) | (cc/g) | (mg) | Index | TS7 | TS750 |
| 1 | 320 | 9.34 | 2.1 | 7.95 | 13.40 | 14.60 |
| 2 | 316 | 9.88 | 1.8 | 7.89 | 14.35 | 13.20 |
| 3 | 281 | 8.59 | 1.7 | 7.08 | 16.70 | 14.01 |
| 4 | 318 | 9.69 | 3.4 | 6.99 | 8.71 | 10.53 |
| 5 | 278 | 8.68 | 2.8 | 7.90 | 10.70 | 9.57 |
| 6 | 254 | 8.13 | 2.6 | 8.56 | 12.60 | 11.94 |
| 7 | 288 | 8.89 | 3.4 | 9.42 | 10.02 | 11.53 |
| 8 | 271 | 8.53 | 2.6 | 8.73 | 12.07 | 10.76 |
| 9 | 276 | 8.84 | 1.1 | 8.65 | 14.27 | 12.51 |
| 10 | 330 | 10.06 | 3.4 | 8.36 | 9.88 | 11.56 |
| 11 | 329 | 10.39 | 2.9 | 9.15 | 10.86 | 10.47 |
| 12 | 273 | 8.85 | 2.8 | 8.98 | 12.83 | 12.86 |

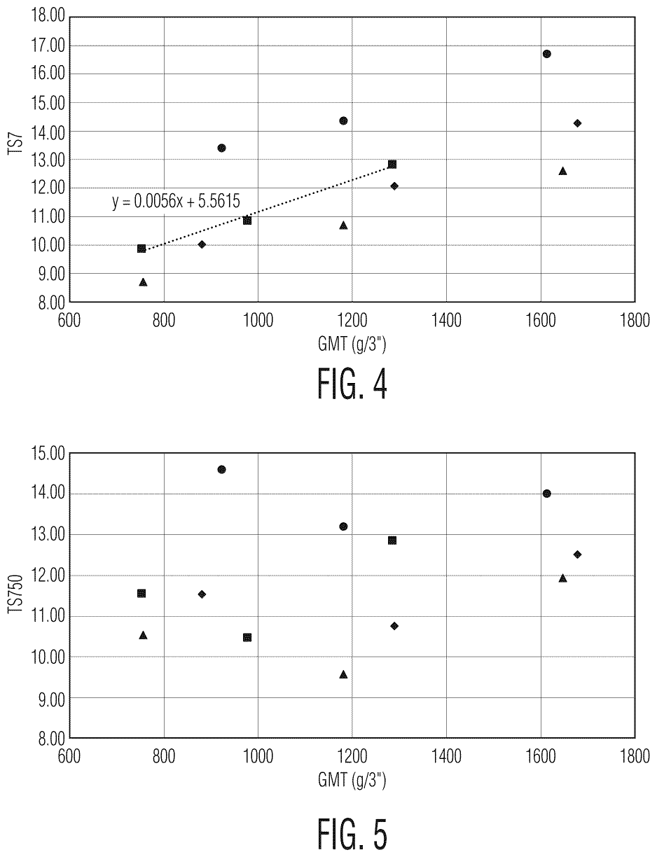

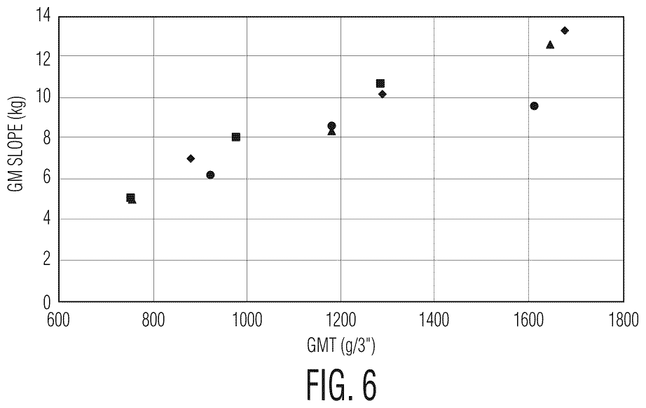

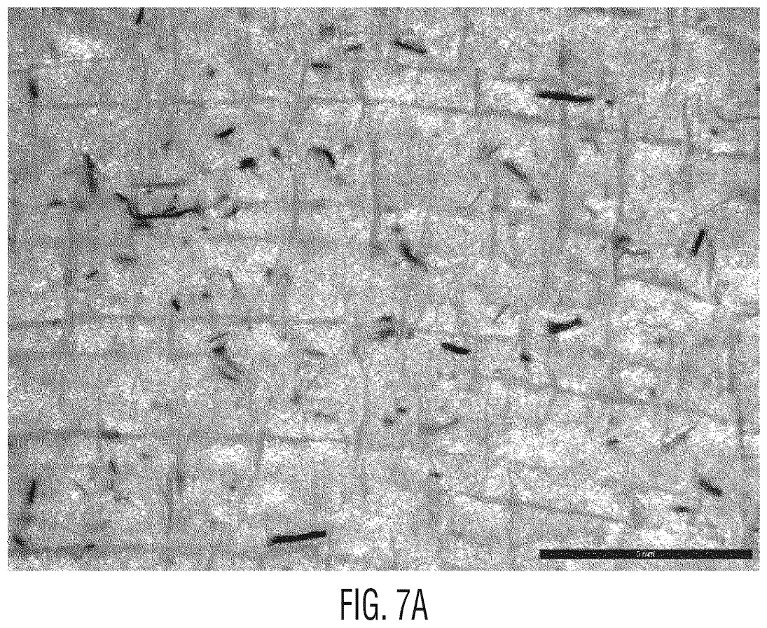

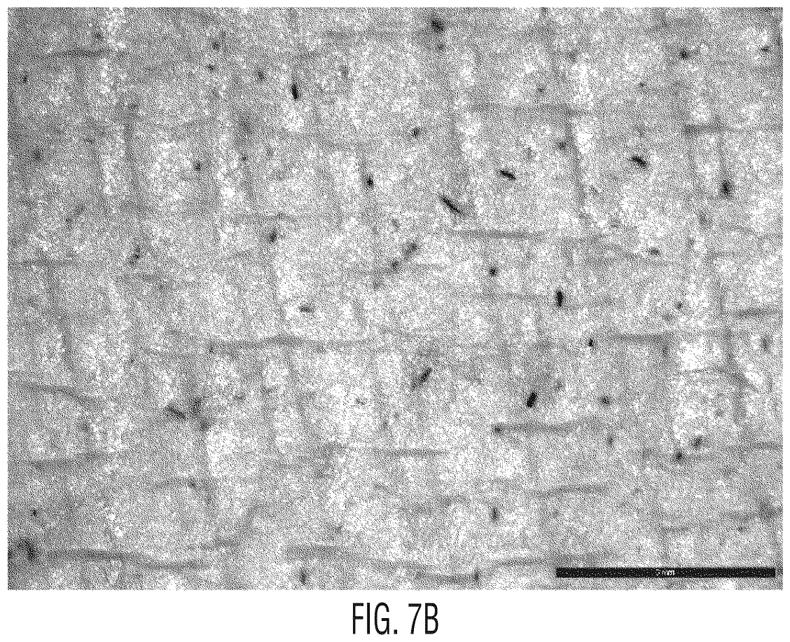

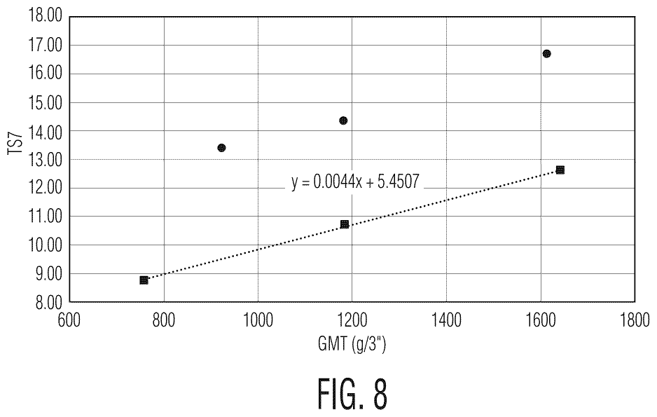

As shown in FIG. 4, the inventive tissue products (samples 4-12) generally had increased softness, measured as TS7, at a given tensile strength, measured as GMT, compared to samples prepared from conventional wood pulp fibers. Further, as shown in FIG. 5, the addition of HYH did not have a negative effect on surface smoothness, even when the fibers were blended and disposed on the outer surface of the tissue product. Finally, as shown in FIG. 6, the substitution of NSWK with HYH did not have a negative effect on product stiffness. The GM Slope of tissue products comprising a blend of HYH and EHWK was comparable to that of similar to tissue products formed entirely from wood pulp fibers (EHWK and NSWK) across a range of tensile strengths.

### Example 2: Single Ply Creped Bath Tissue Product

In this example, tissue webs were made generally according to the process illustrated in FIG. 3. High Yield Hesperaloe pulp (HYH) was produced by processing H. funifera using a high yield pulping process substantially as described in such as described in PCT Application No. PCT/US2021/058196 by cutting the biomass to size, extracting the water soluble solids and impregnating the cut and extracted fiber with an alkaline phosphate solution prior to refining. The primary pulp was subjected to a single bleaching stage and then washed to remove debris. The physical properties of the HYH pulp are summarized in Table 4, below.

TABLE 4

| Fiber | | Very Long | Pulp Debris | | Tensile |
|---|---|---|---|---|---|
| Length | Coarseness | Fiber | Content | Brightness | Index |
| (mm) | (mg/100 m) | Fraction (%) | (%) | (%) | (0 Rev.) |
| 1.85 | 4.5 | 0.06 | 0.4 | 74 | 44 |

The HYH pulp was prepared by dispersing HYH pulp in a pulper for 30 minutes at a consistency of about 3 percent. The fiber was then transferred to a machine chest and diluted to a consistency of 1 percent. The HYH pulp was further diluted to a consistency ranging from about 0.5% before being pumped to the headbox.

In those instances where the web comprised NSWK, NSWK pulp was placed into a pulper and disintegrated for 15 minutes at 4% consistency. Then, the NSWK pulp was refined for 15 minutes, transferred to a dump chest and subsequently diluted to approximately 2% consistency. The NSWK pulp was pumped to a machine chest and further diluted to a consistency ranging from about 0.2-0.3% before being pumped to the headbox.

Eucalyptus hardwood kraft (EHWK) pulp was placed into a pulper and disintegrated for 30 minutes at about 4% consistency. The EHWK pulp was then transferred to a dump chest and subsequently diluted to about 2% consistency. Next, the EHWK pulp slurry was diluted and pumped at about 1% consistency into a machine chest. The pulp slurry was subsequently diluted to about 0.1% consistency and pumped through the headbox.

In all cases the base sheets were produced from various fiber furnishes including, EHWK pulp, NSWK pulp, and HYH. The furnishes were blended together before being pumped to stratified headbox, thus forming a blended tissue web. The blended fiber furnish was subjected to batch refining at 4.5 hp-days/metric ton for specified period of time as set forth in Table 5, below. In other instances, (Redibond™, commercially available from Ingredion Inc., Westchester, IL, U.S.A.) was added to the blended fiber furnish to control strength. The composition of the various tissue webs produced by this example are described in Table 5, below.

TABLE 5

| | EHWK | NSWK | HYH | Refining | Starch |
|---|---|---|---|---|---|
| Sample | (wt %) | (wt %) | (wt %) | (min.) | (kg/tonne) |
| 13 | 75 | 25 | — | 8 | — |
| 14 | 75 | 25 | — | 8 | 3 |
| 15 | 75 | — | 25 | 4 | — |
| 16 | 75 | — | 25 | 4 | — |
| 17 | 75 | — | 25 | 4 | 3 |

The fibers were deposited on a forming fabric. Water was subsequently removed by vacuum. The wet sheet, about 10-20% consistency, was transferred to a press felt or press fabric where it was further dewatered. The sheet was then transferred to a Yankee dryer through a nip via a pressure roll. The consistency of the wet sheet after the pressure roll nip (post-pressure roll consistency or PPRC) was approximately 40%. The wet sheet adhered to the Yankee dryer due to an adhesive that is applied to the dryer surface. Spray booms situated underneath the Yankee dryer sprayed either an adhesive package, which is a mixture of polyvinyl alcohol and Kymene™ (Solenis LLC, Wilmington, DE, U.S.A).

The sheet was dried to about 95% consistency as it traveled on the Yankee dryer and to the creping blade. The creping blade subsequently scraped the tissue sheet off the Yankee dryer. The creped tissue base sheet was then wound onto a 3″ core into soft rolls for converting. The soft rolls were converted into single ply rolled bath tissues by unwinding the rolls, calendaring and then spirally winding the calendared web around a core. The physical properties of the resulting tissue products are reported in Tables 6 and 7, below.

TABLE 6

| | Basis | | GM TEA | GM | GM | Dry | Wet |
|---|---|---|---|---|---|---|---|
| | Weight | GMT | (g · | Slope | Tear | Burst | Burst |
| Sample | (gsm) | (g/3″) | cm/cm²) | (kg) | (gf) | (gf) | (gf) |
| 13 | 14.34 | 682 | 5.5 | 6.6 | 5.3 | 207 | 13.1 |
| 14 | 13.88 | 814 | 7.3 | 6.5 | 6.5 | 262 | 12.3 |
| 15 | 14.85 | 575 | 6.0 | 4.9 | 4.3 | 211 | 22.7 |
| 16 | 13.99 | 572 | 5.6 | 5.1 | 4.3 | 248 | 23.5 |
| 17 | 14.64 | 838 | 8.7 | 7.1 | 5.2 | 311 | 20.7 |

TABLE 7

| | Caliper | Stiffness | | |
|---|---|---|---|---|
| Sample | (μm) | Index | TS7 | TS750 |
| 13 | 259 | 9.74 | 18.0 | 32.5 |
| 14 | 269 | 7.95 | 20.7 | 33.8 |
| 15 | 198 | 8.53 | 13.7 | 20.4 |
| 16 | 191 | 8.88 | 13.6 | 18.9 |
| 17 | 246 | 8.52 | 16.8 | 30.1 |

While tissue webs, and tissue products comprising the same, have been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the foregoing embodiments:

In a first embodiment the present invention provides a creped tissue product comprising at least one creped tissue web comprising at least about 5% high yield hesperaloe pulp fiber, the product having a TS7 value equal or less than 0.0056(GMT)+5.5615 where GMT is the geometric mean tensile strength of the tissue product having units of grams per three inches and a GMT ranging from about 600 g/3″ to about 1,750 g/3″.

In a second embodiment the present invention provides the tissue product of the first embodiment having a Stiffness Index of about 10.0 or less.

In a third embodiment the present invention provides the tissue product of the first or the second embodiments having a Stiffness Index ranging from about 6.0 to about 10.0 and a GM TEA greater than about 9.0 g·cm/cm². In an eleventh embodiment the present invention provides the tissue product of any on the first through the tenth embodiments wherein the product comprises a first and second creped tissue ply.

In a fourth embodiment the present invention provides the tissue product of any one of the first through the third embodiments having a basis weight from 30 to 50 gsm.

In a fifth embodiment the present invention provides the tissue product of any one of the first through the fourth embodiments having a sheet bulk from about 8.0 to about 12.0 cc/g.

In a sixth embodiment the present invention provides the tissue product of any one of the first through the fifth embodiments having a GM Slope from about 5.0 kg to about 10.0 kg.

In a seventh embodiment the present invention provides the tissue product of any one of the first through the sixth embodiments wherein the tissue product comprises from about 10% to about 50% high yield hesperaloe pulp fibers.

In an eighth embodiment the present invention provides the tissue product of any one of the first through the seventh embodiments the tissue product has a TS7 value ranging from about 10.0 to about 15.0.

In a ninth embodiment the present invention provides the tissue product of any one of the first through the eighth embodiments wherein the tissue has a Durability Index greater than about 30.

In a tenth embodiment the present invention provides the tissue product of any one of the first through the ninth embodiments wherein the tissue product is substantially free from NSWK fibers.

In an eleventh embodiment the present invention provides the tissue product of any on the first through the tenth embodiments wherein the product comprises a first and second creped tissue ply.

In a twelfth embodiment the present invention provides the tissue product of any on the first through the eleventh embodiments wherein the product comprises a creped wet pressed tissue ply.

In a thirteenth embodiment the present invention provides the tissue product of any on the first through the twelfth embodiments wherein the product comprises a blend of high yield hesperaloe pulp fibers and wood pulp fibers.

In a fourteenth embodiment the present invention provides the tissue product of any on the first through the thirteenth embodiments wherein the product comprises a first outer surface and a second outer surfaced and wherein at least the first outer surfaces comprises a blend of hesperaloe pulp fibers and wood pulp fibers a water soluble creping composition disposed thereon.

In a fifteenth embodiment the present invention provides a method of manufacturing a creped multiply tissue product comprising the steps of: dispersing high yield hesperaloe pulp fiber in water to form a first fiber slurry; dispersing wood pulp fibers in water to form a second fiber slurry; blending the first and the second fiber slurries together and depositing them on a moving belt to form a tissue web; transferring the tissue web to a felt; pressing the tissue web against the surface of a rotating cylindrical dryer while supported by the felt; drying the tissue web to consistency from about 80 to about 99 percent solids; and creping the dried tissue web from the dryer surface to yield a dried tissue web comprising at least 5%, by weight of the tissue web, high yield hesperlaoe pulp fibers. In certain embodiments, a permanent wet strength agent may be added to one or more of the fiber slurries. In other embodiments, a temporary wet strength agent may be added to one more of the fiber slurries.

In a sixteenth embodiment the present invention provides the method of the seventeenth embodiment wherein the high yield hesperaloe pulp fibers have been produced by mechanically refining hesperaloe biomass without the addition of chemicals.

In a seventeenth embodiment the present invention provides the method of the sixteenth embodiment wherein the high yield hesperaloe pulp fibers have a Fiber Length of at least about 1.50 mm and Coarseness from about 3.5 to about 6.0 mg/100 m.

In an eighteenth embodiment the present invention provides the method of embodiments 16 or 17 further comprising the step of plying two creped tissue webs together to form a creped multiply tissue product.

In a nineteenth embodiment the present invention provides the method of any one of embodiments 16-18 wherein the creped multiply tissue product has a TS7 value from about 10.0 to about 15.0 and a GMT from about 750 g/3″ to about 1,250 g/3″.

In a twentieth embodiment the present invention provides the method of any one of embodiments 16-19 wherein the dried tissue web comprises from about 5% to about 50% high yield hesperaloe pulp fibers.

In a twenty-first embodiment the present invention provides the method of any one of embodiments 16-20 comprising the step of spirally winding the dried tissue web around a core to yield a rolled bath tissue product having a GMT from about 500 to about 1,000 g/3″ and TS7 value less than about 15.0.

In a twenty-second embodiment the present invention provides the method of any one of embodiments 16-21 wherein the rolled bath tissue product has a basis weight from about 13 to about 15 gsm and Stiffness Index less than about 10.0.

What is claimed is:

1. A creped tissue product comprising at least one creped tissue ply, the product having a TS7 value equal or less than 0.0056(GMT)+5.5615 where GMT is the geometric mean tensile strength of the tissue product having units of grams per three inches and a GMT ranging from about 600 g/3″ to about 1,750 g/3″, wherein the product comprises from about 5% to about 50% hesperaloe pulp fibers.

2. The creped tissue product of claim 1 having a Stiffness Index of about 10.0 or less.

3. The creped tissue product of claim 1 having a Stiffness Index ranging from about 6.0 to about 10.0 and a GM TEA greater than about 9.0 g·cm/cm2.

4. The creped tissue product of claim 1 having a basis weight from 30 to 50 gsm.

5. The creped tissue product of claim 1 having a sheet bulk from about 8.0 to about 12.0 cc/g.

6. The multiply creped tissue product of claim 1 having a GM Slope from about 5.0 kg to about 10.0 kg.

7. The creped tissue product of claim 1 wherein the tissue product comprises from about 10% to about 40% hesperaloe pulp fibers.

8. The creped tissue product of claim 1 having a TS7 value ranging from about 10.0 to about 15.0.

9. The creped tissue product of claim 1 having a TS750 value less than about 20.

10. The creped tissue product of claim 1 having a Durability Index greater than about 30.

11. The creped tissue product of claim 1 wherein the tissue product is substantially free from softwood pulp fibers.

12. The creped tissue product of claim 1 having less than about 1.00% Product Debris.

13. A method of manufacturing a creped multiply tissue product comprising the steps of:
a. dispersing high yield hesperaloe pulp fiber in water to form a first fiber slurry;
b. dispersing wood pulp fibers in water to form a second fiber slurry;
c. blending the first and the second fiber slurries together and depositing them on a moving belt to form a tissue web;
d. transferring the tissue web to a felt;
e. pressing the tissue web against the surface of a rotating cylindrical dryer while supported by the felt;
f. drying the tissue web to consistency from about 80 to about 99 percent solids; and
g. creping the dried tissue web from the dryer surface to yield a dried tissue web comprising at least 5%, by weight of the tissue web, high yield hesperlaoe pulp fibers;

14. The method of claim 13 wherein the high yield hesperaloe pulp fibers have been produced by mechanically refining hesperaloe biomass without the addition of chemicals.

15. The method of claim 13 wherein the high yield hesperaloe pulp fibers have a Fiber Length of at least about 1.50 mm and Coarseness from about 3.5 to about 6.0 mg/100 m.

16. The method of claim 13 further comprising the step of plying two creped tissue webs together to form a creped multiply tissue product.

17. The method of claim 13 wherein the creped multiply tissue product has a TS7 value from about 10.0 to about 15.0 and a GMT from about 750 g/3″ to about 1,250 g/3″.

18. The method of claim 13 wherein the dried tissue web comprises from about 5% to about 50% high yield hesperaloe pulp fibers.

19. The method of claim 13 further comprising the step of spirally winding the dried tissue web around a core to yield a rolled bath tissue product having a GMT from about 500 to about 1,000 g/3″ and TS7 value less than about 15.0.

20. The method of claim 19 wherein the rolled bath tissue product has a basis weight from about 13 to about 15 gsm and Stiffness Index less than about 10.0.
